(19) United States
(12) Patent Application Publication
(10) Pub. No.: US 2008/0039313 A1
(43) Pub. Date: Feb. 14, 2008

(54) Process for the Preparation of a Metal-Containing Composition

(76) Inventors: William Jones, Cambridge (GB); Dennis Stamires, Newport Beach, CA (US); Paul O'Connor, Hoevelaken (NL); Michael F. Brady, Studio City, CA (US)

Correspondence Address: Albemarle Netherlands B.V.;Patent and Trademark Department, 451 Florida Street, Baton Rouge, LA, 70801, US

(21) Appl. No.: 11/578,806

(22) PCT Filed: Apr. 26, 2005
(86) PCT No.: PCT/EP05/04556

§ 371 Date: Jul. 2, 2007

Related U.S. Application Data
(60) Provisional application No. 60/565,491, filed on Apr. 26, 2004.

(30) Foreign Application Priority Data
Jul. 8, 2004 (EP) 04076958.0

(51) Int. Cl. B01J 20/08

(52) U.S. Cl. 502/68; 502/63; 502/72; 502/73; 502/74; 502/84

(57) ABSTRACT

Process for the preparation of a metal-containing composition, which process comprises the steps of (a) calcining a physical mixture of an anionic clay and a metal additive at a temperature between 200 and 800° C., and (b) rehydrating the calcined product of step a). This process allows the use of insoluble metal additives. It does not require the use of soluble metal additives, which has economic and environmental advantages.

The present invention relates to the preparation of a metal-containing composition suitable for use as a sulfur oxide sorbent material.

The use of metal-containing compositions as sulfur oxide sorbent material is known from the prior art. In general, these sorbent materials comprise magnesium, aluminium, and preferably a metal additive like a rare earth metal and/or a transition metal such as vanadium.

For instance, U.S. Pat. No. 4,495,305 discloses the use of compositions comprising magnesia-alumina spinel and rare earth metal oxides as sulfur oxide sorbent material. These compositions are prepared by precipitating a water-soluble magnesium inorganic salt and a water-soluble aluminium salt in which aluminium is present in the anion. The precipitate is then dried and calcined to form a spinel phase. Rare earth metals are introduced into the spinel by impregnation or coprecipitation using water-soluble rare earth metal salts.

Another type of sulfur oxide sorbent material is disclosed in EP 0 554 968. This material is a ternary oxide composition comprising 30-50 wt % MgO, 5-30 wt % La₂O₃, 30-50 wt % Al₂O₃, and optionally an additive like ceria and/or vanadia. The preparation of this material involves co-precipitation of lanthanum nitrate, sodium aluminate, and magnesium nitrate and aging and calcining the precipitate. Ceria and/or vanadia are introduced by impregnating the calcined material with a cerium and/or vanadium-containing solution, followed by a second calcination step.

EP 0 278 535 discloses the use of anionic clay as a sulfur oxide sorbent material in FCC processes. This anionic clay is prepared by co-precipitating a divalent metal salt and a trivalent metal salt out of an aqueous solution, followed by aging, filtering, washing, and drying of the precipitate. Optionally, a rare earth metal is incorporated in the anionic clay. This is done either by co-precipitation of a rare earth metal salt with the divalent and the trivalent metal salt, or by impregnation of the anionic clay with a rare earth metal salt.

WO 01/12570 describes the preparation of anionic clay-containing shaped bodies containing a metal additive by preparing a suspension comprising aluminium trihydrate (e.g. gibbsite) and magnesium oxide, shaping the mixture to obtain shaped bodies, and aging the shaped bodies in a slurry comprising a water-soluble salt of the desired metal additive, e.g. cerium nitrate and ammonium vanadate.

The present invention provides a new process for the preparation of a material suitable for use as sulfur oxide sorbent material. The process according to the invention comprises the steps of:
a. calcining a physical mixture of an anionic clay and a metal additive at a temperature between 200 and 800° C., and
b. rehydrating the calcined product of step a).

In contrast to the prior art process mentioned above, the process according to the invention does not require the use of soluble salts as the metal additive. Hence, it allows the use of insoluble compounds like bastnasite (a mixture or rare earth metal compounds), metal carbonates, metal oxides, metal hydroxides, metal bicarbonates, metal hydroxycarbonates etc. to be used in this process as a metal additive.

So, the process according to the invention enables the use of a wider spectrum of metal additives. Furthermore, as it does not necessitate the use of soluble salts, the problems associated with using such salts can be prevented. Typical such problems are contamination of the sulfur oxide sorbent material with the salts' anion (e.g. nitrate, sulphate, chloride) and the formation of environmentally harmful gases like NOₓ, Cl₂, SOₓ, etc upon heating the sulfur oxide sorbent material. Although these problems can be prevented by filtering and washing the material, these processes are industrially undesired and lead to waste water streams containing undesirable anions.

Anionic Clays

Anionic clays have a crystal structure consisting of positively charged layers built up of specific combinations of divalent and trivalent metal hydroxides between which there are anions and water molecules. Hydrotalcite is an example of a naturally occurring anionic clay wherein Mg is the divalent metal, Al is the trivalent metal, and carbonate is the predominant anion present. Meixnerite is an anionic clay wherein Mg is the divalent metal, Al is the trivalent metal, and hydroxyl is the predominant anion present.

A variety of terms is used to describe the material that is referred to in this specification as an anionic clay, such as hydrotalcite-like material and layered double hydroxide. In this specification we refer to these materials as anionic clays, comprising within that term hydrotalcite-like materials and layered double hydroxides.

Suitable trivalent metals (M³⁺) for the anionic clays to be used in the process according to the invention include Al³⁺, Ga³⁺, In³⁺, Bi³⁺, Fe³⁺, Cr³⁺, Co³⁺, Sc³⁺, La³⁺, Ce³⁺, and combinations thereof. Suitable divalent metals (M²⁺) include Mg²⁺, Ca²⁺, Ba²⁺, Zn²⁺, Mn²⁺, Co²⁺, Mo²⁺, Ni²⁺, Fe²⁺, Sr²⁺, Cu²⁺ and combinations thereof.

Specifically preferred anionic clays are Mg—Al anionic clay, Zn—Al anionic clay, Fe—Al anionic clay, Mg—Fe anionic clay, Zn—Fe anionic clay, Mg—Cr anionic clay Mg—Fe—Al anionic clay, Mg—Zn—Al anionic clay, Mg—Al—Ce anionic clay, Mg—Ca—Al anionic clay, Cu—Al anionic clay, Cu—Cr anionic clay, Ni—Al anionic clay, Co—Ni—Al anionic clay, and mixtures of two or more of these anionic clays, such as a mixture of Mg—Al and Zn—Fe anionic clay.

There are various stacking orders for anionic clays, including the regular 3R₁ stacking and the 3R₂ stacking according to WO 01/12550. These can all be used in the process according to the invention. For more information about different stacking orders of anionic clays it is referred to Bookin and Drits, Clay and Clay Minerals, vol. 41, No. 5, pages 551-557 and pages 558-564.

The anionic clay to be used in the process according to the present invention can be prepared by any method known in the art. Three such methods are exemplified below.

A first preparation method involves co-precipitation of a divalent and a trivalent metal source out of an aqueous solution, followed by aging the precipitate.

Optionally, the aged precipitate is thermally treated and rehydrated. Before or after thermal treatment and/or rehydration, the anionic clay can be shaped to form shaped bodies.

A second preparation method involves mixing a trivalent metal source and a divalent metal source in aqueous suspension and aging the mixture to form an anionic clay, optionally followed by a thermal treatment and a rehydration step.

Before or after thermal treatment and/or rehydration, the anionic clay can be shaped to form shaped bodies.

A third preparation method involves mixing a divalent and a trivalent metal source in aqueous suspension, shaping the mixture to form a shaped body, and aging the shaped body in aqueous suspension to form an anionic clay-containing body, optionally followed by a thermal treatment and a rehydration step. Before shaping, some anionic clay, preferably 5-75 wt % of the final amount, might have been formed, although at least a part of the final amount of anionic clay is formed after shaping.

The first preparation method requires the use of soluble divalent and trivalent metal sources, i.e. water-soluble salts. The second and third method use at least one water-insoluble metal source, e.g. an oxide, hydroxide, carbonate, or hydroxy carbonate.

The term aging refers to treatment of the suspension at thermal or hydrothermal conditions for 30 minutes to 3 days. In this context, hydrothermal conditions mean in the presence of water (or steam) at temperatures above 1000° C. and pressures above atmospheric, e.g. autogenous pressure. Thermal conditions refer to temperatures between 15 and 100° C. and atmospheric pressure. Rehydration refers to contacting the thermally treated material with water or an aqueous solution of anions, at thermal or hydrothermal conditions and will be further explained below.

If an excess of divalent and/or trivalent metal source has been used to prepare the anionic clay, compositions of anionic clay and unreacted (meaning: not reacted to anionic clay) divalent and/or trivalent metal source, e.g. brucite, MgO, iron (hydr)oxide and/or zinc (hydr)oxide may have been be formed. Such compositions can also be used in the process according to the invention as the anionic clay.

The term ‘unreacted divalent and/or trivalent metal source’ refers to divalent and/or trivalent metal source not reacted to anionic clay. Hence, boehmite formed from aluminium trihydrate during the anionic clay preparation process is regarded as unreacted aluminium source according to this definition.

Following its preparation, the anionic clay may have been subjected to ion-exchange. Upon ion-exchange the interlayer charge-balancing anions are replaced with other anions. Examples of suitable anions are carbonate, bicarbonate, nitrate, chloride, sulphate, bisulphate, vanadates, tungstates, borates, phosphates, pillaring anions such as HVO₄⁻, V₂O₇⁴⁻, HV₂O₁₂⁴⁻, V₃O₉³⁻, V₁₀O₂₈⁶⁻, Mo₇O₂₄⁶⁻, PW₁₂O₄₀³⁻, B(OH)₄⁻, B₄O₅(OH)₄²⁻, [B₃O₃(OH)₄]⁻, [B₃O₃(OH)₅]²⁻HBO₄²⁻, HGaO₃²⁻, CrO₄²⁻, and Keggin-ions, formate, acetate, and mixtures thereof.

If desired, the pH of the exchange solution is adjusted to ensure that the anion of interest is the anion that is ion-exchanged.

Metal Additive

Suitable metal additives to be used in the process according to the present invention are compounds containing a metal selected from the group of alkaline earth metals (for instance Mg, Ca and Ba), Group IIIA transition metals, group IVA transition metals (e.g. Ti, Zr), Group VA transition metals (e.g. V, Nb), Group VIA transition metals (e.g. Cr, Mo, W), Group VIIA transition metals (e.g. Mn), Group VIIIA transition metals (e.g. Fe, Co, Ni, Ru, Rh, Pd, Pt), Group IB transition metals (e.g. Cu), Group IIB transition metals (e.g. Zn), Group IIIB elements (e.g. Al, Ga), Group IVB elements (e.g. Si, Sn), lanthanides (e.g. La, Ce), and mixtures thereof, provided that this metal differs from the divalent and the trivalent metal constituting the anionic clay of step a).

Preferred metals are Ce, V, Zn, La, W, Mo, Fe, and Cu.

The metal additive is preferably an oxide, hydroxide, carbonate, or hydroxycarbonate of the desired metal.

Calcination

The first step of the process involves calcination of a physical mixture of an already formed anionic clay and a metal additive. So, the process of this invention starts with an already existing anionic clay, which is then mixed with the additive. It should be emphasized that the preparation of the physical mixture involves the addition of an additive to a completely formed anionic clay. It does not comprise the addition of an additive to a mixture of divalent and trivalent compounds which is still in the process of anionic clay formation and in which mixture less than 100% of the final amount of anionic clay has been formed.

This physical mixture can be prepared in various ways. Anionic clay and metal additive can be mixed as dry powders or in (aqueous) suspension thereby forming a slurry, a sol, or gel. In the latter case, the metal additive and the anionic clay are added to the suspension as powders, sols, or gels and the preparation of the mixture is followed by drying.

It is also possible to prepare such a physical mixture by impregnating the anionic clay with a solution of the metal additive. It is however preferred to use undissolved metal additives (so: as dry power, in slurry, sol, or gel) for the preparation of the physical mixture.

The metal additive content in the physical mixture preferably ranges from 1 to 60 wt %, more preferably 1 to 30 wt %, and most preferably 5 to 20 wt %, calculated as oxides The anionic clay content in the physical mixture preferably ranges from 40 to 99 wt %, more preferably 70 to 99 wt %, and most preferably 80 to 95 wt %, all percentages based on dry solids content.

Preferably, the physical mixture is milled before calcination. The anionic clay and the metal additive can be milled as dry powders or in suspension. Alternatively, or in addition to milling of the physical mixture, the anionic clay and the metal additive are milled individually before forming the physical mixture. Equipment that can be used for milling include ball mills, high-shear mixers, colloid mixers, kneaders, electrical transducers that can introduce ultrasound waves into a slurry, and combinations thereof.

If the physical mixture is prepared in aqueous suspension, dispersing agents can be added to the suspension. Suitable dispersing agents include aluminium chlorohydrol, alumina gels, phosphates (e.g. ammonium phosphate, aluminium phosphate), surfactants, sugars, starches, polymers, gelling agents, swellable clays, etc. Acids or bases may also be added to the suspension.

Before calcination, the physical mixture can be shaped to form shaped bodies.

Examples of suitable shaping methods are spray-drying, pelletising, extrusion, and beading.

The physical mixture is calcined at a temperature in the range of 200-800° C., more preferably 300-700° C., and most preferably 350-600° C. Calcination is conducted for 0.25-25 hours, preferably 1-8 hours, and most preferably 2-6 hours. All commercial types of calciners can be used, such as fixed bed or rotating calciners.

Calcination can be performed in various atmospheres, e.g, in air, oxygen, inert atmosphere (e.g. N₂), steam, or mixtures thereof.

The so-obtained calcined material must contain rehydratable oxide. The amount of rehydratable oxide formed depends on the type of anionic clay, the metal additive, and the calcination temperature. Preferably, the calcined material contains 5-100 wt % of rehydratable oxide, more preferably 30-100 wt %, and most preferably 50-100 wt % of rehydratable oxide, all calculated as oxides and based on the total weight of the composition calculated as oxides.

The amount of rehydratable oxide can be calculated as follows. The intensity of the, for anionic clays characteristic, 003 powder X-ray diffraction line is measured before calcination and after calcination and rehydration. The intensity of the line after rehydration relative to the intensity before calcination (expressed in wt %) is taken as the percentage of rehydratable oxide present in the calcined material after step a). From this, the wt % of rehydratable oxide in the total composition can be calculated.

An example of a non-rehydratable oxide is a spinel phase.

In another embodiment of the invention, the preparation and calcination of the physical mixture are conducted in one step. In that case, the metal additive is added to the anionic clay during calcination thereof. For this method it is required to use a calciner which has sufficient mixing capability and can be effectively used as mixer as well as calciner.

It is also possible to combine the methods above by first preparing a physical mixture of anionic clay and metal additive, followed by addition of a different or an additional amount of the same metal additive during calcination.

Rehydration

Rehydration of the calcined material is conducted by contacting the calcined mixture with water or an aqueous solution of anions. This can be done by passing the calcined mixture over a filter bed with sufficient liquid spray, or by suspending the calcined mixture in the liquid. The temperature of the liquid during rehydration is preferably between 25 and 350° C., preferably between 25 and 200° C., more preferably between 50 and 150° C., the temperature of choice depending on the nature of the anionic clay and the type and amount of metal additive. Rehydration is performed for about 20 minutes to 20 hours, preferably 30 minutes to 8 hours, more preferably 1-4 hours.

During rehydration the suspension can be milled by using high-shear mixers, colloid mixers, ball mills, kneaders, electrical transducers that can introduce ultrasound waves into a slurry, etc.

Rehydration can be performed batch-wise or continuously, optionally in a continuous multi-step operation according to pre-published United States patent application no. 2003-0003035. For example, the rehydration suspension is prepared in a feed preparation vessel, whereafter the suspension is continuously pumped through two or more conversion vessels. If so desired, additional additives, acids, or bases, can be added to the suspension in any of the conversion vessels. Each of the vessels can be adjusted to its own desirable temperature.

Examples anions suitably present in the rehydration liquid include inorganic anions like NO₃⁻, NO₂⁻, CO₃²⁻, HCO₃⁻, SO₄²⁻, SO₃NH₂²⁻, SCN⁻, S₂O₆²⁻, SeO₄⁻, F⁻, Cl⁻, Br⁻, I⁻, ClO₃⁻, ClO₄⁻, BrO₃⁻, and IO₃⁻, silicate, aluminate, and metasilicate, organic anions like acetate, oxalate, formate, long chain carboxylates (e.g. sebacate, caprate and caprylate (CPL)), alkylsufates (e.g. dodecylsulfate (DS) and dodecylbenzenesulfate), stearate, benzoate, phthalocyanine tetrasulfonate, and polymeric anions such as polystyrene sulfonate, polyimides, vinylbenzoates, and vinyldiacrylates, and pH-dependent boron-containing anions, bismuth-containing anions, thallium-containing anions, phosphorus-containing anions, silicon-containing anions, chromium-containing anions, vanadium-containing anions, tungsten-containing anions, molybdenum-containing anions, iron-containing anions, niobium-containing anions, tantalum-containing anions, manganese-containing anions, aluminium-containing anions, and gallium-containing anions.

Additionally, it is possible to incorporate additional metals during rehydration. These additional metals and the metal present in the metal additive of step a) are independently selected from the group of alkaline earth metals (for instance Mg, Ca and Ba), Group IIIA transition metals, group IVA transition metals (e.g. Ti, Zr), Group VA transition metals (e.g. V, Nb), Group VIA transition metals (e.g. Cr, Mo, W), Group VIIA transition metals (e.g. Mn), Group VIIIA transition metals (e.g. Fe, Co, Ni, Ru, Rh, Pd, Pt), Group IB transition metals (e.g. Cu), Group IIB transition metals (e.g. Zn), Group IIIB elements (e.g. Al, Ga), Group IVB elements (e.g. Si, Sn), lanthanides (e.g. La, Ce), and mixtures thereof. However, the additional metal and the metal present in the metal additive both differ from the divalent and the trivalent metal constituting the anionic clay of step a).

Depending on the type of anionic clay, the type of metal additive, the calcination temperature and the rehydration conditions, the resulting metal-containing composition can be (i) an anionic clay with the metal originating from the metal additive distributed therein and/or incorporated in the layers of the anionic clay, or (ii) a mixed oxide comprising a divalent metal, a trivalent metal, and the metal originating from the metal additive.

It is also possible to rehydrate the calcined material in the presence of an ammonium transition metal compound, e.g. ammonium heptamolybdate, ammonium tungstate, ammonium vanadate, ammonium dichromate, ammonium titanate, and/or ammonium zirconate. This may lead to the formation of a cationic layered material according to D. Levin, et al. (Chem. Mater. Vol. 8, 1996, pp. 836-843; ACS Symp. Ser. Vol. 622, 1996, pp. 237-249; Stud. Surf, Sci. Catal. Vol. 118, 1998, pp. 359-367).

The metal-containing composition prepared according to the process of the invention can subsequently be calcined and optionally rehydrated again to form a metal-containing composition.

The so-formed calcined material can be used as a catalyst or sorbent for various purposes, such as FCC processes. If this calcination is followed by a subsequent rehydration, a metal-containing composition is formed analoguous to the composition formed after the first rehydration step, but with an increased mechanical strength.

These second calcination and rehydration steps may be conducted under conditions which are either the same or different from the first calcination and rehydration steps.

Additional metals may be incorporated during this additional calcination step and/or during this rehydration step. These additional metals, the additional metals optionally incorporated during rehydration step b) (i.e. the first rehydration step) and the metal present in the metal additive of step a) are independently selected from the group of alkaline earth metals (for instance Mg, Ca and Ba), Group IIIA transition metals, group IVA transition metals (e.g. Ti, Zr), Group VA transition metals (e.g. V, Nb), Group VIA transition metals (e.g. Cr, Mo, W), Group VIIA transition metals (e.g. Mn), Group VIIIA transition metals (e.g. Fe, Co, Ni, Ru, Rh, Pd, Pt), Group IB transition metals (e.g. Cu), Group IIB transition metals (e.g. Zn), Group IIIB elements (e.g. Al, Ga), Group IVB elements (e.g. Si, Sn), lanthanides (e.g. La, Ce), and mixtures thereof. However, the additional metals and the metal present in the metal additive are different from the divalent and the trivalent metal constituting the anionic clay of step a).

Furthermore, during this additional rehydration step, anions can be added. Suitable anions are the ones mentioned above in relation to the first rehydration step. The anions added during the first and the additional rehydration step can be the same or different.

If so desired, the metal-containing composition prepared according to the process of present invention can be mixed with conventional catalyst or sorbent ingredients such as silica, alumina, aluminosilicates, zirconia, titania, boria, (modified) clays such as kaolin, acid leached kaolin, dealuminated kaolin, acid activated montmorillonite or saponite, smectites, and bentonite, (modified or doped) aluminium phosphates, zeolites (e.g. zeolite X, Y, REY, USY, RE-USY, or ZSM-5, zeolite beta, silicalites), phosphates (e.g. meta or pyro phosphates), pore regulating agents (e.g. sugars, surfactants, polymers), sorbents, fillers, and combinations thereof.

It is also possible to add these catalyst or sorbent ingredients to the physical mixture to be calcined or during the rehydration step.

The metal-containing composition, optionally mixed with one, or more of the above conventional catalyst components, can be shaped to form shaped bodies. Suitable shaping methods include spray-drying, pelletising, extrusion (optionally combined with kneading), beading, or any other conventional shaping method used in the catalyst and sorbent fields or combinations thereof.

Use of the Metal-Containing Composition

The metal-containing composition prepared by the process according to the invention is very suitable for use as sulfur oxide sorbent material. Hence, the material can be incorporated for this purpose in FCC catalysts or FCC catalyst additives. Additionally, the metal-containing composition can be used for the adsorption of sulfur oxide emission from other sources, like power plants. As sulfur oxide sorbent-materials are generally good nitrogen oxide sorbent materials, the metal-containing composition will likewise be suitable as nitrogen oxide sorbent material in, e.g., FCC catalysts, FCC catalyst additives, etc.

Furthermore, the metal-containing composition can be used for other purposes, such as removing gases like HCN, ammonia, Cl₂, and HCl from steel mills, power plants, and cement plants, for reduction of the sulphur and/or nitrogen content in fuels like gasoline and diesel, as additives for the conversion of CO to CO₂, and in or as catalyst compositions for Fischer-Tropsch synthesis, hydroprocessing (hydrodesulfurisation, hydrodenitrogenation, demetallisation), hydrocracking, hydrogenation, dehydrogenation, alkylation, isomerisation, Friedel Crafts processes, ammonia synthesis, etc.

If so desired, the metal-containing composition can be treated with organic agents, thereby making the surface of the clay—which is generally hydrophilic in nature—more hydrophobic. This allows for the metal-containing composition to disperse more easily in organic media.

When applied as nanocomposites (i.e. particles with a diameter less then about 500 nm), the metal-containing composition can suitably be used in plastics, resins, rubber, and polymers. Nanocomposites with a hydrophobic surface, for instance obtained by treatment with an organic agent, are especially suited for this purpose.

The metal-containing composition may also be pillared, delaminated and/or exfoliated using known procedures.

### EXAMPLES

### Example 1

A slurry was prepared by dispersing 91.2 g commercial hydrotalcite (ex-Reheis; Mg/Al mole ratio of 2.2) in 694 g distilled water.

A solution was prepared by dissolving 16.0 g lanthanum nitrate in 41 g distilled water. This solution was added to the previously prepared slurry. The pH of the resulting slurry was adjusted to 9 with ammonium hydroxide, then immediately dried in a convection oven at 110° C. The dried powder was calcined at 500° C. for four hours.

A 20.0 g portion of the resulting calcined powder was rehydrated in 650 g of a 1 M sodium carbonate solution overnight at 85° C. The slurry was then filtered, washed with distilled water and dried at 110° C.

The amount of rehydratable oxide (measured as described in the specification above) present after calcination was 90%.

### Example 2

A slurry was prepared by dispersing 91.2 g commercial hydrotalcite (ex-Reheis; Mg/Al mole ratio of 2.2) in 694 g distilled water. To this slurry a solution of 7.97 g lanthanum nitrate dissolved in 21 g distilled water and 3.08 g of BaO were added. The pH of the resulting slurry was adjusted to 9 with ammomium hydroxide, and the slurry was then immediately dried in a convection oven at 110° C. The dried powder was calcined at 500° C. for four hours.

A 20.0 g portion of the resulting calcined powder was rehydrated in 650 g of a 1 M sodium carbonate solution overnight at 85° C. The slurry was then filtered, washed with distilled water and dried at 110° C.

The amount of rehydratable oxide present after calcination was 95%.

### Example 3

A slurry was prepared by dispersing 91.2 g commercial hydrotalcite (ex-Reheis; having Mg/Al mole ratio of 2.2) in 694 g distilled water. To this slurry 13.52 g ferrous oxalate was added. The pH of the resulting slurry was adjusted to 9 with ammomium hydroxide, then immediately dried in a convection oven at 110° C. The dried powder was calcined at 500° C. for four hours.

A 20.0 g portion of the resulting calcined powder was rehydrated in 650 g of a 1 M sodium carbonate solution overnight at 85° C. The slurry was then filtered, washed with distilled water and dried at 110° C.

The amount of rehydratable oxide present after calcination was 100%.

### Example 4

A slurry was prepared by dispersing 91.2 g commercial hydrotalcite (ex-Reheis; Mg/Al mole ratio of 2.2) in 694 g distilled water. To this slurry 12.99 g cerium carbonate was added. The pH of the resulting slurry was adjusted to 9 with ammomium hydroxide, then immediately dried in a convection oven at 110° C. The dried powder was calcined at 500° C. for four hours.

A 20.0 g portion of the resulting calcined powder was rehydrated in 650 g of a 1M sodium carbonate solution overnight at 85° C. The slurry was then filtered, washed with distilled water and dried at 110° C. The amount of rehydratable oxide present after calcination was 80%.

### Example 5

A slurry was prepared by dispersing 91.2 g commercial hydrotalcite (ex-Reheis; Mg/Al mole ratio of 2.2) in 694 g distilled water. To this slurry 9.72 g manganese carbonate was added. The pH of the resulting slurry was adjusted to 9 with ammomium hydroxide and high shear mixed in a Waring blender. The resulting slurry was immediately dried in a convection oven at 110° C. The dried powder was calcined at 350° C. for two hours.

A 20.0 g portion of the resulting calcined powder was rehydrated in 650 g of a 1 M sodium carbonate solution overnight at 85° C. The slurry was then filtered, washed with distilled water and dried at 110° C.

The amount of rehydratable oxide present after calcination was 100%.

### Example 6

The products of Examples 3 and 4 were tested for their de-SOₓ ability in FCC processes using the thermographimetric test described in Ind. Eng. Chem. Res. Vol. 27 (1988) pp. 1356-1360. A standard commercial de-SOₓ additive was used as a reference.

Known weights of the samples and the same weight of the standard commercial additive were heated under nitrogen at 700° C. for 30 minutes. Next, the nitrogen was replaced by a gas containing 0.32% SO₂, 2.0% O₂, and balance N₂ with a flow rate of 200 ml/min. After 30 minutes the SO₂-containing gas was replaced by nitrogen and the temperature was reduced to 650° C. After 15 minutes, nitrogen was replaced by pure H₂ and this condition was maintained for 20 minutes. This cycle was repeated 3 times. The sample's SOₓ uptake and its release during hydrogen treatment were measured as the sample's weight change (in %).

The ratio of SOₓ release over SOₓ uptake was defined as the effectiveness ratio The ideal effectiveness ratio is 1, which means that all the SOₓ that was taken up has been released again, leading to a longer catalyst life.

Table 1 indicates the effectiveness ratio of the samples prepared relative to the effectiveness ratio of the commercial de-SOₓ additive:the SOₓ improvement. A SOₓ improvement of 1 means that the prepared sample has the same effectiveness ratio as the commercial additive. An improvement higher than 1 indicated that a higher effectiveness ratio was obtained.

TABLE 1

| Example | SOₓ improvement |
|---|---|
| 3 | 2.7 |
| 4 | 1.47 |

This table shows that with the process according to the invention, compositions can be prepared which are very suitable for use as additives in FCC process for the reduction of SOₓ emissions.

1. A process for the preparation of a metal-containing composition, which process comprises the steps of:
a) calcining a physical mixture of an anionic clay and a metal additive at a temperature between 200 and 800° C., and
b) rehydrating the calcined product of step a).

2. The process according to claim 1 wherein the physical mixture is milled before calcination.

3. The process according to claim 1 wherein the physical mixture is formed during calcination.

4. The process according to claim 1 wherein the calcination temperature ranges from 300 to 700° C.

5. The process according to claim 4 wherein the calcination temperature ranges from 400 to 600° C.

6. The process according to claim 1 wherein the calcined product is rehydrated in an aqueous solution of anions.

7. The process according to claim 1 wherein the anionic clay comprises a divalent metal cation selected from the group consisting of Mg²⁺, Ca²⁺, Ba²⁺, Zn²⁺, Mn²⁺, Co²⁺, Mo²⁺, Ni²⁺, Fe²⁺, Sr²⁺, Cu²⁺, and mixtures thereof.

8. The process according to claim 1 wherein the anionic clay comprises a trivalent metal cation selected from the group consisting of Al³⁺, Ga³⁺, In³⁺, Bi³⁺, Fe³⁺, Cr³⁺, Co³⁺, Sc³⁺, La³⁺, Ce³⁺, and mixtures thereof.

9. The process according to claim 1 wherein the metal additive is a compound comprising an element selected from the group consisting of transition metals, rare earth metals, alkaline earth metals, noble metals, phosphorus and silicon.

10. The process according to claim 9 wherein the element is selected from the group consisting of Ce, Zn, V, La, W, Mo, Fe, and Cu.

11. The process according to claim 1 wherein the physical mixture comprises one or more additional compounds selected from the group consisting of alumina, silica, silica-alumina, magnesia, titania, boria, phosphates, zeolites, and clays.

12. The process according to claim 1 followed by calcination of the product of step b).

13. The process according to claim 12 followed by rehydration of the product of step b).

14. The process according to claim 1 wherein the physical mixture has been shaped before calcination.
